(19) United States
(12) Patent Application Publication
(10) Pub. No.: US 2026/0279696 A1
(43) Pub. Date: Sep. 17, 2026

(54) Breaker Lockout with Pivoting Clamping Surface

(71) Applicant: Tradebase Holdings LC, Sheridan, WY (US)

(72) Inventor: Sean L Hennessy, Scottsdale, AZ (US)

(21) Appl. No.: 19/081,460

(22) Filed: Mar. 17, 2025

(51) Int. Cl. H01H 9/20; H01H 71/02

(52) U.S. Cl. CPC H01H 9/20; H01H 71/02

(57) ABSTRACT

A breaker lockout device for a circuit breaker is provided. The breaker lockout device includes a body positionable on the circuit breaker when a toggle of the circuit breaker is in an OFF position and a first securing mechanism to engage the body with the circuit breaker. The breaker lockout device further includes a second securing mechanism to lock the toggle in the OFF position. The breaker lockout device further includes a pivoting clamping member within the body, configured to adjust to the toggle's angle and engage a lower surface of the toggle with full-surface contact during locking.

### TECHNICAL FIELD

The present invention relates to an adjustable circuit breaker lockout device configured to secure breaker toggles in a fixed position, preventing unintended activation, by incorporating a pivoting clamping surface that adapts—manually or automatically—to varying toggle angles across diverse circuit breaker designs, ensuring full-surface contact and enhanced safety.

### BACKGROUND

Generally, Circuit breakers are widely used across residential, commercial, industrial, aeronautics, naval, and other electrical systems to protect equipment, infrastructure, and personnel by automatically interrupting electrical flow when hazardous conditions occur. Circuit breakers offer a convenient means to disconnect power during maintenance and repair operations, where unintentional reactivation of a breaker can pose severe risks, including electric shock, machinery malfunction, and workplace accidents.

To mitigate these risks, circuit breaker lockout devices are used to secure breaker toggles in the OFF position and prevent unauthorized or accidental reactivation. However, existing lockout devices often suffer from poor fitment and unreliable engagement, primarily due to variations in breaker designs. Different breaker manufacturers produce toggles with slightly different angles when in the OFF position, meaning that a rigid, non-adjustable clamping surface may only partially contact the toggle instead of fully securing it. This incomplete contact can lead to instability and a weaker lockout mechanism, reducing overall safety.

The key challenge in ensuring a universal, secure fit across various breaker designs is the inconsistent toggle angles produced by different manufacturers. Conventional lockout devices typically rely on a fixed or flat clamping surface, which does not conform to the precise angle of the toggle. For instance, fixed clamping surfaces in devices like U.S. Pat. No. 5,732,815 may contact only a fraction of a toggle's surface if its angle deviates significantly, increasing slippage risk under typical forces. As a result, existing devices often fail to achieve full-surface contact, reducing grip strength and increasing the likelihood of unintended displacement, require multiple variations or additional adjustments that add cost and complexity, or lack adaptability, forcing users to resort to makeshift solutions.

To address these shortcomings, the present invention introduces a breaker lockout device with an adjustable, pivoting clamping surface that adjusts—manually or automatically —to the toggle's precise angle, ensuring full contact and significantly greater grip strength than fixed-surface designs. Key features include a pivoting clamping surface that prevents partial engagement, dual adjustment methods (manual positioning before installation or automatic adjustment upon tightening), a sandwiching effect for maximum stability and tamper resistance, and universal compatibility across breaker designs without requiring multiple versions or modifications.

By addressing the limitations of conventional breaker lockout devices, this invention significantly improves safety and ease of use in industrial, commercial, residential, aeronautics, naval, and other electrical systems, for example. The adjustable, pivoting clamping surface ensures that the lockout device maintains consistent, full-contact engagement, regardless of breaker design, enhancing the effectiveness and reliability of electrical lockout procedures.

Some methods and devices are known to incorporate various mechanisms for breaker lockout devices. For example, U.S. Pat. No. 5,732,815 discloses a lockout device employing a screw as the securing means of the toggle. The screw presses against one side of the toggle, causing the other side of the toggle to be pressed against the fixed-angle surface of the lockout device. An imperfect fit is likely, as the toggle's angle often differs from the fixed-angle surface's. This design's use of a single set screw also means that the lockout device's sole means for staying in place against the breaker face is indirectly via the toggle. The embodiments of the present invention will show how these two critical limitations are surmounted to achieve a secure fit against the unknown angle of the toggle while ensuring the breaker lockout device attaches directly and securely to the face of the breaker.

In another example, U.S. Pat. No. 11,037,740 also discloses a lockout device employing a screw as the securing means of the toggle. The screw presses against one side of the toggle, causing the other side of the toggle to be pressed against the fixed-angle clamping surface of the lockout device. An imperfect fit is likely, as the toggle's angle often differs from the fixed-angle surfaces. This design also uses the single set screw to simultaneously push an extendible cleat against the breaker face. This cleat is either retracted (disengaged) or extended (engaged), such that it has no adjustability of the force applied other than provided by the single screw. The embodiments of the present invention will show how these two critical limitations are surmounted to achieve a secure fit against the unknown angle of the toggle while ensuring the breaker lockout device attaches directly and securely to the face of the breaker with a means for independently controlling the attachment force.

### SUMMARY

In one aspect of the present invention, a breaker lockout device for a circuit breaker is provided. The breaker lockout device includes a body positionable on the circuit breaker when a toggle of the circuit breaker is in an OFF position and a first securing mechanism to engage the body with the circuit breaker. The breaker lockout device further includes a second securing mechanism to lock the toggle in the OFF position. The breaker lockout device further includes a pivoting clamping member within the body, configured to adjust to the toggle's angle and engage a lower surface of the toggle with full-surface contact during locking.

Other aspects of the disclosed invention will become apparent from the following detailed description, the accompanying drawings, and the appended claims.

### BRIEF DESCRIPTION OF FIGURES

Notwithstanding any other forms which may fall within the scope of the present invention, preferred embodiments of the disclosure will now be described, by way of example only, with reference to the accompanying drawings in which: to the drawings, in which:

FIG. 1 illustrates a front perspective view of a breaker lockout device designed to secure a circuit breaker toggle in a fixed position, and including an adjustable, pivoting clamping surface, which ensures full-surface contact with the breaker toggle, in accordance with an embodiment of the present disclosure.

FIG. 2 shows a left-hand side sectional view of a circuit breaker and the breaker lockout device of FIG. 1 vertically cut through the center of the breaker lockout device and the circuit breaker;

FIG. 3 shows a left-hand side sectional view of the circuit breaker and the breaker lockout device similar to that of FIG. 2, but with the breaker lockout device partially positioned against the circuit breaker such that the pivoting clamping surface has not yet accommodated the angle of the toggle, and the cleat has not been tightened against the breaker's crevice.

FIG. 4 shows another left-hand side sectional view of the circuit breaker and the breaker lockout device similar to that of FIG. 3, but with the breaker lockout device fully positioned against the circuit breaker such that the pivoting clamping surface has accommodated the angle of the toggle, and the cleat has been tightened against the breaker's crevice.

FIG. 5 shows a bottom perspective view of the breaker lockout device of FIGS. 1-3, in accordance with an embodiment of the present disclosure.

FIG. 6 shows a rear perspective view of the breaker lockout device of FIGS. 1-4, showing the full structure and orientation of the securing components, in accordance with an embodiment of the present disclosure.

FIG. 7 shows a front perspective view of a breaker lockout device (such as the breaker lockout device of FIGS. 1-5), in accordance with another embodiment of the present disclosure.

FIG. 8 is a sectional view taken along lines 8-8 of FIG. 4, providing a detailed look at the internal structure of the locking mechanism, including the positioning of the clamping surface relative to the breaker toggle; and

FIG. 9 is a rear view of the rear groove of the pivoting clamping member of the breaker lockout device with the stop rib being received in the rear groove of the pivoting clamping member and with portions of the stop rib being broken away for illustrative purposes.

### DETAILED DESCRIPTION OF THE EMBODIMENTS

The example embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

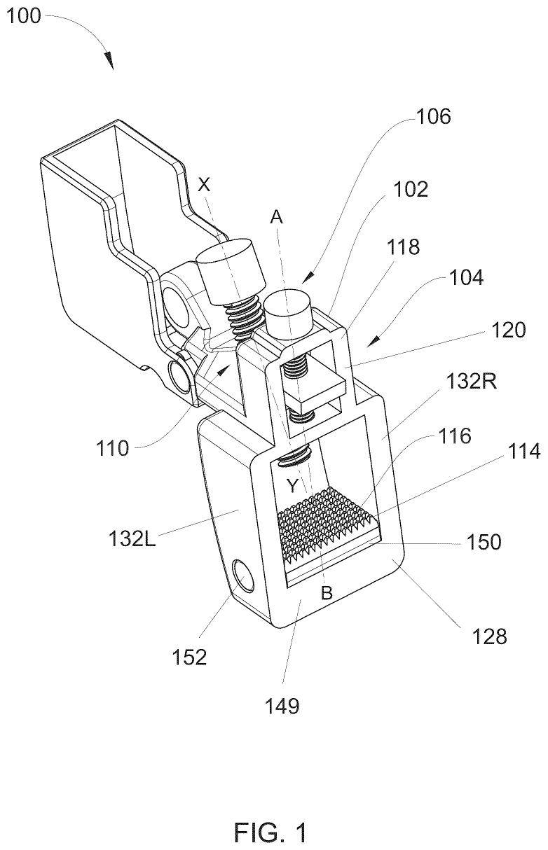

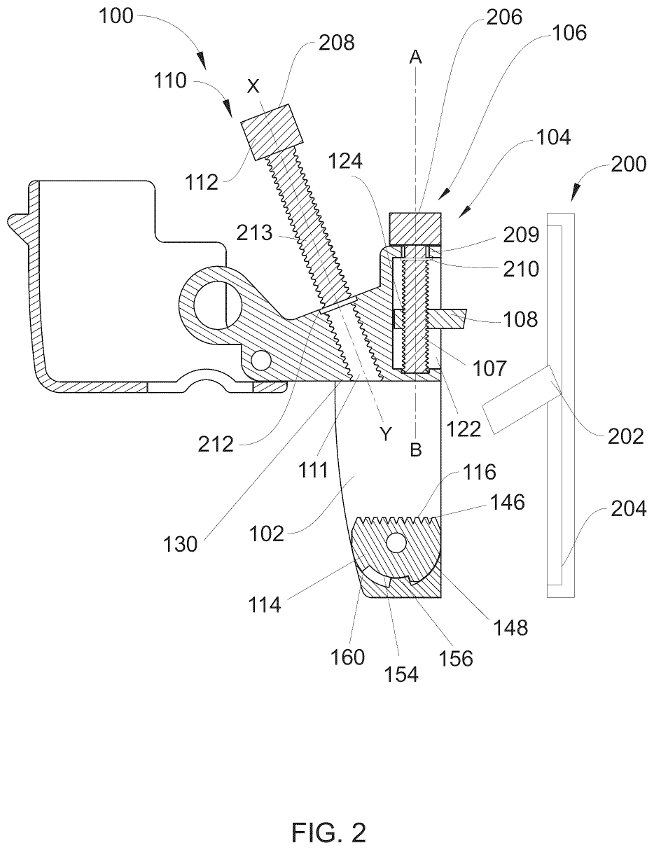

Throughout the present description, the terms “upper”, “lower”, “top”, “bottom”, “left”, “right”, “front”, “forward”, “rear”, and “rearward” shall define directions or orientations with respect to the apparatus as illustrated in FIG. 1. It will be understood that the spatially relative terms “upper”, “lower”, “top”, “bottom”, “left”, “right”, “front”, “forward”, “rear”, and “rearward” are intended to encompass different orientations of the apparatus in use or operation in addition to the orientation depicted in the figures. For example, if the apparatus in the figures is turned over, elements described as “upper” elements or features would then be “lower” elements or features. The terms “down”, “downward”, “up”, and “upward” define directions or orientations relative to the circuit breaker 200 as viewed in FIG. 2.

When the circuit breaker's toggle is in the “ON” position, downstream circuits to be energized. When the circuit breaker's toggle is in the “OFF” position, downstream circuits will be deenergized. Those skilled in the art will know that the “OFF” position of the circuit breaker is desirable for working on the associated downstream circuits. The “OFF” position is the one used for applying the breaker lockout device.

FIG. 1 shows a front perspective view of a breaker lockout device 100 for a circuit breaker 200 (shown in FIG. 2), in accordance with an embodiment of the present disclosure. The breaker lockout device 100 comprises a body 102 to be positioned on the circuit breaker 200 when a switch 202 (shown in FIG. 2) of the circuit breaker 200 is in a downward OFF position. The body 102 acts as the housing that holds the internal components and interfaces with the external surfaces of the circuit breaker 200. The body 102 comprises a front portion 118 that has a first peripheral wall 120 the defines a first opening 122 (FIG. 2). The body 102 can be fabricated from materials such as high-impact resistant plastics, including but not limited to polycarbonate or acrylonitrile butadiene styrene (ABS), to ensure durability and resistance to external forces. Alternatively, for more rugged industrial applications, the body 102 can be fabricated from metals such as aluminum or stainless steel to enhance strength and longevity.

FIG. 1 shows a front perspective view of a breaker lockout device 100 for a circuit breaker 200 (shown in FIG. 2), in accordance with an embodiment of the present disclosure. The breaker lockout device 100 comprises a body 102 to be positioned on the circuit breaker 200 when a toggle 202 (shown in FIG. 2) of the circuit breaker 200 is in a OFF position. The body 102 acts as the housing that holds the internal components and interfaces onto the external surfaces of the circuit breaker 200. The body 102 comprises a front portion 118 that has a first peripheral wall 120 the defines a first opening 122 (FIG. 2). The body 102 can be fabricated from materials such as high-impact resistant plastics, including but not limited to polycarbonate or acrylonitrile butadiene styrene (ABS), to ensure durability and resistance to external forces. Alternatively, for more rugged industrial applications, the body 102 can be fabricated from metals such as aluminum or stainless steel to enhance strength and longevity.

The body 102 plays the role of the structural foundation, providing protection to the internal mechanisms and ensuring that the breaker lockout device 100 can endure environmental wear and tampering efforts. Additionally, the shape of the body 102 can be designed to fit different types of circuit breakers. For example, a rectangular or trapezoidal shape may be used for the body 102 depending on the dimensions of the circuit breaker 200, ensuring a snug and secure fit. The body 102 can be fabricated in different sizes and thicknesses depending on the environment, such as high-humidity or dust-prone areas, where the circuit breaker 200 is implemented. Such design flexibility ensures compatibility with a wide range of breakers, enhancing the versatility of the breaker lockout device 100.

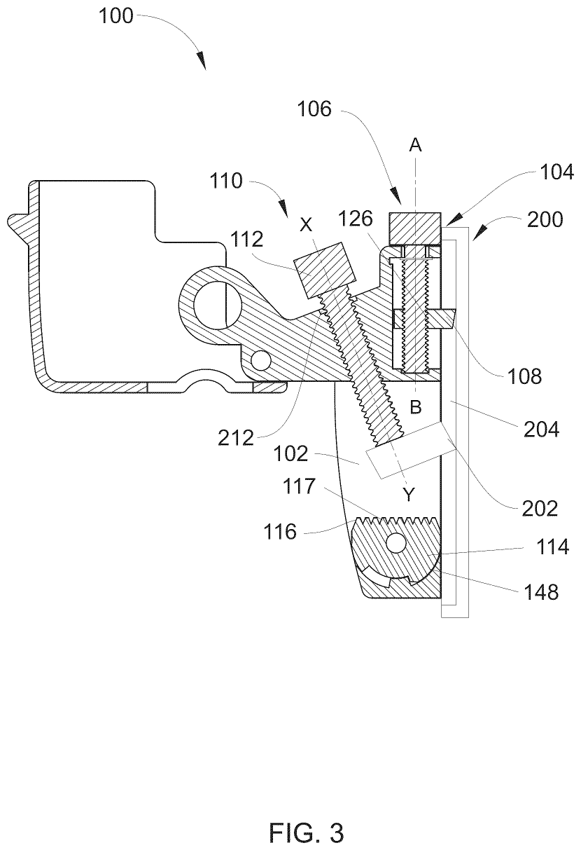

The breaker lockout device 100 further comprises an adjustable cleat mechanism 104 disposed within the front portion 118 of the body 102. The adjustable cleat mechanism 104 comprises a first screw 106 that extends through the first peripheral wall 120 of the front portion 118 of the body 102. The first screw 106 is disposed along a first axis AB. A cleat 108 (FIG. 2) is threadedly disposed on the first screw 106 with the first screw 106 extending through an aperture 124 (FIG. 2) in the cleat 108 and threadedly engaging an inner side 126 (FIG. 3) of the cleat 108 that defines the aperture 124. The cleat 108 is located in the first opening 122 of the front portion 118 of the body 102. Rotation of the first screw 106 about the first axis AB does not move the first screw 106 along the first axis AB, since there is no threaded connection of the first screw 106 to the first peripheral wall 120. However, the threaded connection of the first screw 106 to the inner side 126 of the cleat 108 causes the cleat 108 to move along the first axis AB upon rotation of the first screw 106 about the first axis AB.

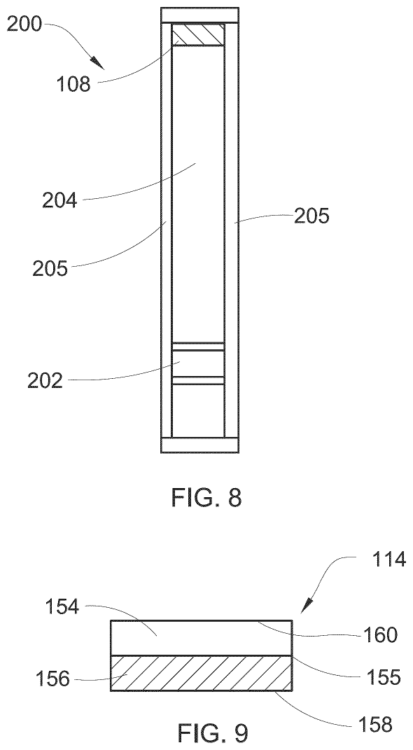

The cleat mechanism 104 can be fabricated from materials such as stainless steel or reinforced polymers to ensure durability and resistance to deformation under pressure. The cleat 108 moves upwards or downwards (relative to the circuit breaker 200 and toggle as viewed in FIGS. 2 and 3) along the first axis AB when the first screw 106 is rotated about the first axis AB, engaging a vertical crevice 204 (shown in FIG. 2) of the circuit breaker 200. The portion of the crevice 204 above the toggle 202 slidingly receives a portion of the cleat 108 that extends outside the body. As illustrated in FIG. 8, the cleat 108 is positioned between opposite side walls 205 of the crevice 204. The opposite side walls 205 prevent lateral movement of the cleat 108 as the cleat 108 moves upwards and downwards to selected position along the crevice 204 and when the cleat 108 is at those selected positions along the crevice 204. This adjustable movement allows the cleat mechanism 104 to accommodate different crevice sizes and breaker models, providing a secure engagement to prevent tampering.

The cleat 108 ensures that the breaker lockout device 100 can fit various circuit breakers, making it adaptable to different breaker models. The cleat 108 can be fabricated in different shapes, such as triangular or rounded, to accommodate the geometry of the crevice 204 and ensure proper engagement. These shapes may also employ additional elements, such as texturizing to improve the frictional grip with the breaker face. The use of hardened materials for the cleat 108 further enhances the security of the engagement with the circuit breaker 200, reducing the chances of deformation or wear over time.

The first screw 106, which adjusts the position of the cleat 108, can be fabricated from materials such as steel, brass or titanium. These materials may be used by themselves or in combination with other materials. The cleat 108 may also utilize oxidations or coatings which provide favorable characteristics, such as frictional grip to the breaker face.

The first screw 106 can be a thumbscrew but may be any helical fastener requiring a twisting force to move. The head of the first screw 106 may utilize other known operators, including slotted, Phillips, hex, Allen, and so on.

The rotation of the first screw 106 enables precise movement of the cleat 108, allowing the user to adjust the engagement based on the dimensions of the circuit breaker 200. The length of the first screw 106 and a thread pitch associated therewith can vary depending on the level of adjustment needed, with finer threads offering more precise movement and coarser threads allowing quicker adjustments.

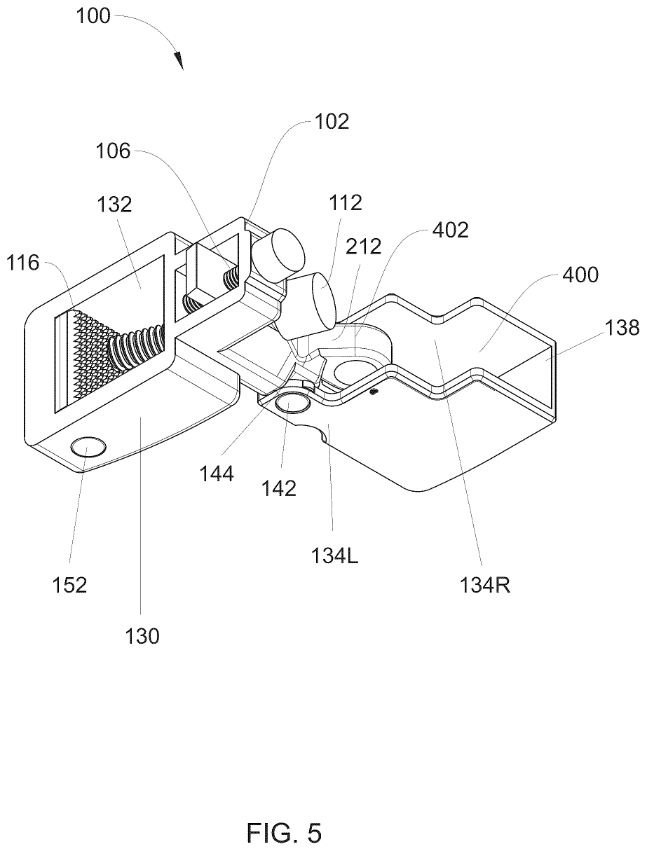

Referring to FIGS. 1-4, the breaker lockout device 100 additionally comprises a locking mechanism 110 disposed within a rear portion 128 (FIG. 1) of the body 102. The locking mechanism 110 comprises a second screw 112 (FIG. 2) threadedly disposed in a threaded bore 111 (FIG. 2) of a second peripheral wall 130 of the rear portion 128 of the body 102 along a second axis XY, which is non-parallel to the first axis AB. The second screw 112 extends through the second peripheral wall 130 into a second opening 132 (FIG. 5) defined by the second peripheral wall 130 (FIG. 2).

The second screw 112 can be fabricated from materials such as steel or brass, similar to the first screw 106. The second screw 112 can be a thumbscrew but may be any helical fastener requiring a twisting force to move. The head of 106 may utilize other known operators, including slotted, Phillips, hex, Allen, and so on.

The second screw is responsible for locking the toggle 202 of the circuit breaker 200, which toggle 202 extends into the second opening 132 (FIG. 5). Further, as illustrated in FIG. 3, when the second screw 112 is rotated clockwise about the second axis XY, the second screw 112 moves along the second axis XY towards the toggle 202 until the end of the second screw 112 engages and locks against the toggle 202, preventing any movement of the toggle 202, thus securing the circuit breaker 200 in a locked position.

The non-parallel arrangement of the axes AB and XY allows the first screw 106 and the second screw 112 to operate independently without mechanical interference, ensuring smooth and reliable operation of the breaker lockout device 100. The second screw 112 can vary in size and length depending on the dimensions of the circuit breaker 200, allowing for flexibility in application across different breaker types.

The breaker lockout device 100, when assembled with the body 102, the adjustable cleat mechanism 104, the first screw 106, the cleat 108, the locking mechanism 110 and the second screw 112, provide a comprehensive solution for preventing tampering with the circuit breaker 200. The first screw 106 enables precise engagement of the cleat 108 with the crevice 204 of the circuit breaker 200, while the second screw 112 ensures that the toggle 202 remains locked in place. The overall structure and design of the breaker lockout device 100 allow for secure and adaptable use across a variety of circuit breaker models, offering both versatility and robust tamper prevention.

In a first example, the breaker lockout device 100 can be used in a hospital environment where critical life-saving equipment is connected to the power grid through circuit breakers. In such an example, tampering with a circuit breaker could disrupt the operation of ventilators or other essential devices, potentially endangering patients. The adjustable cleat mechanism 104 allows the breaker lockout device 100 to fit a wide range of breaker models commonly used in medical facilities, ensuring reliable operation and preventing unauthorized access.

In a second example, the breaker lockout device 100 can be implemented in an industrial setting where machinery is connected to high-power circuit breakers. Tampering with or accidental activation of such circuit breakers could lead to the unintended startup of machinery, posing serious safety risks to personnel and equipment. The use of the breaker lockout device 100 in such environments ensures that the circuit breakers remain securely locked, preventing accidental or unauthorized activation. The durability of the materials used in the body 102 and the cleat mechanism 104 is designed to withstand the harsh conditions of industrial settings, ensuring reliable functionality even under heavy use and exposure to demanding environmental factors.

FIG. 2 shows a left-hand side sectional view of the breaker lockout device 100 of FIG. 1, in accordance with an embodiment of the present disclosure. As shown, the breaker lockout device 100 is positioned in front (relative to the circuit breaker 200) of the circuit breaker 200. The toggle 202 of the circuit breaker 200 is in an OFF position.

FIG. 3 shows a left-hand side sectional view of the breaker lockout device 100 of FIG. 2, in accordance with an embodiment of the present disclosure. As shown, the first screw 106 is rotated to cause downward movement of the cleat 108 along the axis AB. The downward movement of the cleat 108 enables precise positioning of the cleat 108 in alignment with the crevice 204 of the circuit breaker 200, ensuring secure engagement and preventing tampering. In this view, the cleat 108 is shown fully engaged with the crevice 204, further stabilizing the breaker lockout device 100 on the circuit breaker 200.

Moreover, the toggle 202 of the circuit breaker 200 is in the OFF position, which is necessary to properly install the breaker lockout device 100. The second screw 112 has been rotated along the axis XY to lock the second screw 112 against the toggle 202. The application of the second screw 112 not only locks the toggle 202 in place but also prevents unauthorized toggling of the circuit breaker 200, ensuring full lockout functionality. Such movement of each of the first screw 106 and the second screw 112 in coordination with the specific geometry of the circuit breaker 200 provides a comprehensive locking solution, securing both the toggle 202 and the breaker body. The dual-screw mechanism of the breaker lockout device 100 enhances safety by providing redundant locking points, offering improved reliability in high-risk or high-security environments.

FIG. 5 shows a bottom perspective view of the breaker lockout device 100 of FIGS. 1-4, in accordance with an embodiment of the present disclosure. As shown, the body 102 comprises a pivotable safety cover 400. The pivotable safety cover 400 is designed to be positioned over the first screw 106 and the second screw 112, offering protection and preventing unauthorized tampering. In the engaged state of the pivotable safety cover 400, access to each of the first screw 106 and the second screw 112 is restricted, ensuring that the breaker lockout device 100 remains securely in place without the risk of adjustment (such as tampering) or removal.

The pivotable safety cover 400 can be fabricated from durable materials, such as high-impact resistant plastics or metals, to provide enhanced security and withstand environmental factors. The safety cover 400 includes opposite side walls 134R, 134L interconnected by an intermediate wall 136 (FIG. 5) that collectively define a channel 138. The design of the pivotable safety cover 400 comprises a pivoting mechanism that allows the safety cover 400 to pivot relative to the body 102 between engaged and disengaged positions. The pivoting mechanism may comprise a pivot pin 142 that laterally extends through apertures in the side walls 134R, 134L and a passageway in a connecting portion 144 of the body 102, which connecting portion 144 is positioned in the channel 138 between the side walls 134R, 134L in the disengaged position. In the engaged position, the body 102 is received in the channel 138 such that the cover 400 covers the front portion 118 and the first and second screws 106, 112. In the disengaged state, the pivotable safety cover 400 allows access to each of the first screw 106 and the second screw 112, enabling adjustments to be made as necessary. The pivoting feature simplifies the process of engaging and disengaging the cover 400, improving ease of use while maintaining robust security.

This design adds an extra layer of protection against tampering by physically covering the key adjustment mechanisms, ensuring that only authorized personnel can access and adjust the screws, further enhancing the overall safety and reliability of the breaker lockout device 100.

Moreover, the body 102 comprises a hasp 402 configured to receive a padlock in the engaged state of the pivotable safety cover 400. The hasp 402 is positioned on the external surface of the body 102 and is designed to provide an additional locking mechanism when the pivotable safety cover 400 is in the engaged state. Further, the securing of the padlock through the hasp 402 further prevents unauthorized access to the first screw 106 and the second screw 112, enhancing the tamper-resistance of the breaker lockout device 100.

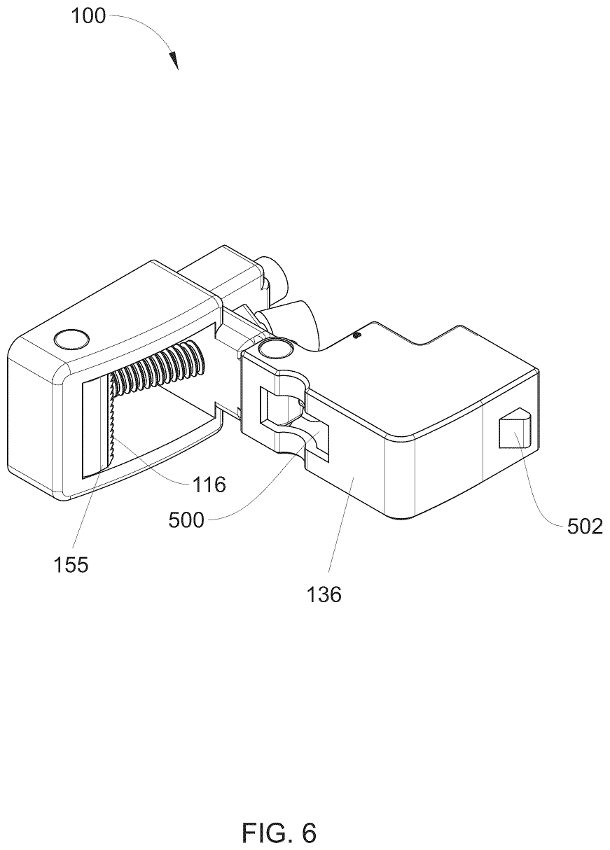

The pivotable safety cover 400 also comprises an opening 500 (shown in FIG. 6) to receive the hasp 402 when the pivotable safety cover 400 is in the disengaged state. This opening 500 ensures that the pivotable safety cover 400 can be securely moved between the engaged and disengaged positions without obstruction, allowing easy access to the screws when necessary. The inclusion of the hasp 402 provides flexibility in implementing a padlock, offering an additional layer of security to lock the breaker lockout device 100 in place, making it suitable for high-security environments where multiple layers of tamper prevention are required.

FIG. 6 shows a rear perspective view of the breaker lockout device 100 of FIGS. 1-5, in accordance with an embodiment of the present disclosure. As shown, the pivotable safety cover 400 comprises a finger tab 502 disposed on an external surface thereof. The finger tab 502 is strategically positioned to facilitate easy engagement and disengagement of the pivotable safety cover 400, allowing authorized users to quickly access or secure the first screw 106 and the second screw 112.

The finger tab 502 can be fabricated from the same material as the pivotable safety cover 400, such as high-impact resistant plastic or metal, ensuring durability and ease of operation. The design of the finger tab 502 is ergonomically considered, allowing users to grip and pivot the safety cover 400 without requiring additional tools, improving the overall functionality of the breaker lockout device 100. The inclusion of the finger tab 502 enhances user convenience, making it easier to operate the safety cover in environments where frequent access to the screws may be required, while maintaining the security of the system when in the engaged state.

Referring to FIG. 2, the first screw 106 comprises a first screwhead 206 and the second screw 112 comprises a second screwhead 208. The body 102 comprises the opening or first receptacle 209 to receive the first screw 106. The first receptacle 209 is designed with a diameter lesser than that of the first screwhead 206, ensuring that the first screwhead 206 remains seated securely within the receptacle 209 and does not pass through. This configuration provides structural integrity and prevents the first screw 106 from slipping out of position during operation. The precise fit between the first screwhead 206 and the first receptacle 209 ensures reliable functionality and minimizes the risk of mechanical failure. Additionally, or instead of the first receptacle 209, a shank 107 of the first screw 106 may pass through a washer 210 located on the outer side of the first peripheral wall 120. The opening in the washer may be designed with a diameter lesser than that of the first screwhead 206, ensuring that the first screwhead 206 remains seated securely within the receptacle 209 and does not pass through.

Further, the body 102 also comprises a second receptacle 212 to receive the second screw 112. Similarly, the second receptacle 212 is designed with a diameter lesser than the diameter of the second screwhead 208. This arrangement ensures that the second screwhead 208 remains securely seated in the second receptacle 212 during operation, providing the same mechanical stability as the first screw 106. The secure engagement of both screwheads within their respective receptacles helps maintain the overall stability of the breaker lockout device 100, ensuring that both screws operate independently and reliably without the risk of dislodgement. Additionally, or instead of the second receptacle 212, a shank 213 of the first screw 106 may pass through a washer located on the outer side of the first peripheral wall 120. The opening in the washer may be designed with a diameter lesser than that of the first screwhead 206, ensuring that the first screwhead 206 remains seated securely within the receptacle 209 and does not pass through.

Further, the first screwhead 206 and the second screwhead 208 prevent contact of the first screw 106 with the second screw 112 during complete engagement of the first screw 106 within the first receptacle 209 and the second screw 112 within the second receptacle 212. The size and positioning of the screwheads 206 and 208 ensure that each screw remains within its designated receptacle without interference. This separation maintains the functionality of both the adjustable cleat mechanism 104 and the locking mechanism 110, allowing independent operation of the first screw 106 and the second screw 112. The design ensures that no mechanical stress is transferred between the first screw 106 and the second screw 112, enhancing the overall durability and reliability of the breaker lockout device 100 during prolonged use or in high-tampering-risk environments.

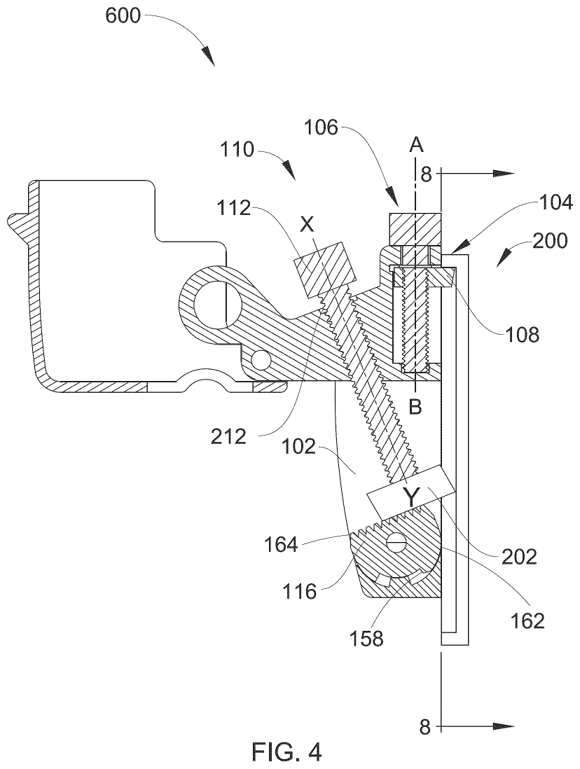

Referring to FIG. 1, the body 102 comprises a generally semi-cylindrical pivoting clamping member 114 disposed therein. The pivoting clamping member includes a flat front side 146 and a curved rear side 148 as illustrated in FIGS. 2 and 3. The pivoting clamping member 114 comprises a plurality of projections 116 disposed on the front side 146 (FIG. 2) that define a clamping surface 117 (FIG. 3). The pivoting clamping member 114 is designed to be positioned underneath the toggle 202 of the circuit breaker 200 during the locking of the second screw 112 against the toggle 202 as seen in FIG. 4. The pivoting clamping member 114 acts to provide a solid grip to the toggle 202. The pivoting clamping member 114 also distributes the force applied by the second screw 112 to prevent damage to the toggle 202 caused by excessive pressure. This component ensures that the locking mechanism 110 operates smoothly while preserving the integrity of the circuit breaker 200, especially during repeated use of the breaker lockout device 100 in high-stress environments. The pivoting clamping member 114 can be fabricated from materials such as reinforced polymer or rubber, providing the necessary flexibility and durability to protect the toggle 202 from wear over time.

As shown, the pivoting clamping member 114 is pivotally disposed within the second peripheral wall 130 of the rear portion 128 of the body 102. Specifically, the pivoting clamping member 114 is disposed between right and left wall portions 132R, 132L with the curved rear side 148 slidably contacting an inner side 150 of a rear wall portion 149 of the second peripheral wall 130. A pivot pin 152 extends into the right and left wall portions 132R, 132L and through the pivoting clamping member 114 along a longitudinal axis of the pivoting clamping member 114 to enable the pivoting clamping member 114 to pivot about the pivot pin 152. A rear groove 154 is formed at the outer surface of the pivoting clamping member 114 and extends longitudinally between opposite axial ends 155 of the pivoting clamping member 114 as illustrated in FIGS. 2, 3, 4, and 9. A stop rib 156 is integrally formed in one piece with the rear wall portion 149 on the inner side 150 of the rear wall portion 149 and extends longitudinally along the rear wall portion 149 as illustrated in FIGS. 2, 3, 4, and 9. The stop rib 156 also extends inwardly from the inner side 150 into the rear groove 154 of the pivoting clamping member 114. This arrangement enables the pivoting clamping member 114 to pivot in a range of selected positions between a first position in which the stop rib 156 engages the lower side 158 (FIG. 4) of the rear groove 154 such that the flat front side 146 of the pivoting clamping member 114 is perpendicular to the first axis AB as shown in FIGS. 2 and 3, and a second position in which the stop rib 156 engages the upper side 160 of the groove such that a lower portion 162 (FIG. 4) of the flat front side 146 extends further forwardly or inwardly into the second opening 132.

This enables the pivoting clamping member 114 to rotate such that its upper portion 164 (FIG. 4) can pivot at selected positions within a range of 0 to −45 degrees, allowing the upper portion 164 to tilt backward but not forward, accommodating toggle angle variations common across circuit breaker designs. In alternative embodiments, broader ranges of motion may be achieved using different pivot mechanisms, such as a hinge, ball joint, or flexible material, provided the clamping member adjusts to ensure full-surface engagement with the toggle.

The rotation of the pivoting clamping member 114 can be manually adjusted prior to installation or occur automatically as the breaker lockout device 100 is secured to the circuit breaker. In one embodiment, securing is achieved by engaging a tightening mechanism (e.g., rotating the second screw 112 clockwise), which presses the toggle 202 against the pivoting clamping member 114, causing the member to pivot about its support (e.g., pin 152) until the clamping surface 117 aligns flush with the toggle's angle, typically within the 0 to −45 degree range, ensuring full contact without manual intervention. Unlike fixed-surface devices (e.g., U.S. Pat. No. 5,732,815), which may leave gaps and slip under lateral forces, the pivoting clamping member 114 eliminates such gaps, significantly enhancing grip strength.

This pivotal arrangement allows the pivoting clamping member 114 to adapt to different toggle positions, ensuring consistent protection and force distribution regardless of the angle or position of the toggle 202. For example, FIG. 4 shows the pivoting clamping member 114 positioned approximately midway between the lower and upper sides 158, 160 of the rear groove 154.

The pivotable nature of the pivoting clamping member 114 enhances the flexibility of the breaker lockout device 100, making it compatible with a wider range of circuit breaker designs while maintaining effective functionality. This design ensures that the pivoting clamping member 114 can pivot into the optimal position underneath the toggle 202 during the locking process, further reducing the risk of damage to the toggle 202.

Moreover, the projections 116 contact the toggle 202 during the locking of the second screw 112 against the toggle 202. These projections 116 provide additional grip between the pivoting clamping member 114 and the toggle 202, ensuring that the toggle 202 remains securely in place during the locking process. The projections 116 also help distribute the force applied by the second screw 112 more evenly, preventing localized pressure points that could damage the toggle 202. This design enhances both the stability and the protective function of the pivoting clamping member 114, ensuring reliable operation of the breaker lockout device 100 while extending the lifespan of the toggle 202.

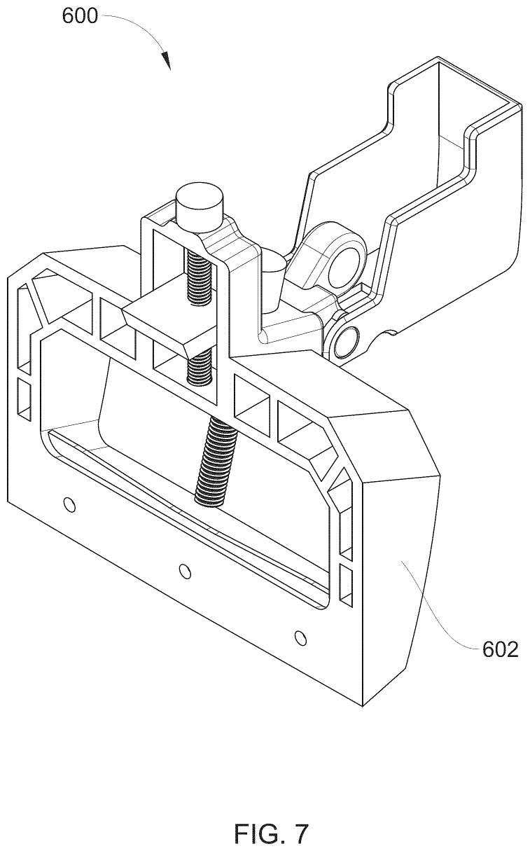

FIG. 7 shows a front perspective view of a breaker lockout device 600 (such as the breaker lockout device 100 of FIGS. 1-5), in accordance with an embodiment of the present disclosure. As shown, dimensions of the body 602 of the breaker lockout device 600 are bigger than dimensions of the circuit breaker 200. This design ensures that the breaker lockout device 600 provides full coverage over the circuit breaker 200, preventing unauthorized access to any part of the breaker. The larger body 602 also enhances the overall structural stability of the breaker lockout device 600, allowing it to be securely mounted on a variety of breaker models. Additionally, the increased size provides space for the internal components, such as the cleat mechanism and locking mechanism, to function without interference, ensuring reliable operation of the device in environments where tampering risks are high.

Thus, the present disclosure provides an adjustable securing mechanism for a circuit breaker lockout device, designed to prevent unintended operation of breaker's toggle. The device features an adjustable, pivoting clamping surface that conforms to the orientation of a breaker toggle, ensuring secure and stable lockout engagement.

The adjustable, pivoting clamping surface can pivot within a predefined range, allowing it to conform to toggles of an unknown angle This directional adjustment enhances compatibility with various circuit breaker designs while maintaining structural stability.

The pivoting adjustment may occur either manually or automatically as the securing mechanism is engaged. Upon activation, the adjustable, pivoting clamping surface interacts with the breaker toggle, conforming to its position to ensure firm and reliable lockout engagement.

The device includes a tightening mechanism that applies force toward the breaker toggle, increasing security and stability in engagement. This allows for consistent functionality across different breaker models while ensuring ease of installation and removal.

The pivoting action of the adjustable, pivoting clamping surface prevents unintended loosening while allowing controlled tightening. This mechanism enhances operational reliability and safety, minimizing the risk of accidental disengagement.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

The foregoing description and accompanying figures illustrate the principles, embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

1. A breaker lockout device comprising:
a body positionable on a circuit breaker when a toggle of the circuit breaker is in an OFF position;
a first securing mechanism to engage the body with the circuit breaker;
a second securing mechanism to lock the toggle in the OFF position; and
a pivoting clamping member within the body, configured to adjust to the toggle's angle and engage a lower surface of the toggle with full-surface contact during locking.

2. The breaker lockout device of claim 1, wherein the pivoting clamping member is adjustable manually prior to installation or automatically upon engagement of the second securing mechanism.

3. The breaker lockout device of claim 1, wherein the first securing mechanism comprises a first screw and a cleat disposed on the first screw, wherein rotation of the first screw about a first axis moves the cleat to engage the body with a crevice of the circuit breaker.

4. The breaker lockout device of claim 3, wherein the second securing mechanism comprises a second screw, wherein rotation of the second screw locks the toggle in the OFF position.

5. The breaker lockout device of claim 1, wherein the pivoting clamping member is pivotally disposed within the body.

6. The breaker lockout device of claim 1, wherein the pivoting clamping member comprises a plurality of projections disposed on a first surface thereof that contacts the toggle during locking.

7. The breaker lockout device of claim 6, wherein the first surface is flat.

8. The breaker lockout device of claim 5, wherein the pivoting clamping member includes a groove formed on its outer surface, wherein the body comprises a stop rib, wherein the groove receives the stop rib, wherein the stop rib engages a first side of the groove when the pivoting clamping member is at a first position, and engages a second side of the groove opposite the first side when the pivoting clamping member is at a second position, wherein the pivoting clamping member pivots at selected positions between the first and second positions.

9. The breaker lockout device of claim 6, wherein the pivoting clamping member has an upper portion that pivots within a range of 0 to −45 degrees relative to the first surface.

10. The breaker lockout device of claim 1, wherein the body comprises a pivotable safety cover that:
prevents access to the first securing mechanism and the second securing mechanism in an engaged state of the pivotable safety cover; and
allows access to the first securing mechanism and the second securing mechanism in a disengaged state of the pivotable safety cover.

11. The breaker lockout device of claim 10, wherein the pivotable safety cover comprises a finger tab disposed on an external surface thereof.

12. The breaker lockout device of claim 4, wherein the first screw comprises a first screwhead and the second screw comprises a second screwhead, and wherein the body comprises:
a first receptacle to receive the first screw, wherein a diameter of the first receptacle is less than a diameter of the first screwhead; and
a second receptacle to receive the second screw, wherein a diameter of the second receptacle is less than a diameter of the second screwhead.

13. The breaker lockout device of claim 12, wherein the first screwhead and the second screwhead prevent contact between the first screw and the second screw during complete engagement of the first screw within the first receptacle and the second screw within the second receptacle.
